(19) United States
(12) Patent Application Publication
(10) Pub. No.: US 2017/0059347 A1
(43) Pub. Date: Mar. 2, 2017

(54) Determining Improved Pick-Up Locations

(71) Applicant: GOOGLE INC., MOUNTAIN VIEW, CA (US)

(72) Inventors: Holger-Frederik Robert Flier, Zurich (CH); Cesar Morais Palomo, Campinas (BR)

(21) Appl. No.: 14/838,471

(22) Filed: Aug. 28, 2015

(51) Int. Cl. G01C 21/36; H04W 4/02

(52) U.S. Cl. CPC G01C 21/3605; H04W 4/02

(57) ABSTRACT

Systems and methods are provided for determining candidate pick-up locations. For instance, responsive to receiving a request from a user for a ride, one or more candidate pick-up locations proximate a current location of the user can be determined. The candidate pick-up locations can be determined at least in part by ranking a plurality of locations proximate the current location of the user in view of one or more travel parameters and a destination specified by the user. The user may select a candidate pick-up location as a selected pick-up location, and the selected pick-up location may be provided to a car service or ride share platform to facilitate a pick-up.

### FIELD

The present disclosure relates generally to determining pick-up locations, and more particularly to systems and methods for determining improved pick-up locations based at least in part on one or more travel parameters.

### BACKGROUND

With the increased popularity of mobile computing devices, car rides, such as taxi, car, or limousine rides, are increasingly being reserved or otherwise ordered via mobile platforms. For instance, ride share platforms can be used to coordinate rides for passengers with private drivers. More particularly, a driver that is travelling along a similar route during a similar time as a passenger can be provided an opportunity to give the passenger a ride in exchange for some form of compensation or incentive. For instance, ride share platforms can receive requests from passengers for a ride between an origin and a destination during a given time period. The ride share platform can identify drivers suitable for giving the passenger the ride along the travel route. The ride share platform can present offers to the identified drivers to give a ride to the passenger. The offers can include compensation for giving the passenger a ride. The compensation can be determined based on various factors, such as distance of detour by the driver to give the passenger a ride, auction bidding, or based on supply and demand. When a driver accepts an offer, the passenger can be alerted that a ride has been arranged for the passenger. The ride share platform can navigate the driver to the passenger location and along the travel route requested by the passenger.

For instance, a user may order a car ride from a ride share platform or other car service by providing a starting location and a destination location to the ride share platform or other car service via a mobile application, and upon receiving the order, the ride share platform or car service may send a vehicle to the starting location. Conventional car ordering techniques may allow a user to specify a current location as the starting location For instance, the current location can be determined by the mobile computing device without the user having to expressly specify a starting point. For example, the current location can be a location determined based on GPS, IP address, cell triangulation, proximity to Wi-Fi access points, proximity to beacon devices, or other techniques. The determined location can correspond to raw location data. For example, the current location can be a geocode that identifies a latitude and longitude.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of determining one or more pick-up locations. The method includes receiving, by one or more computing devices, location data associated with a user. The method further includes, determining, by the one or more computing devices, at least one candidate pick-up location proximate the user based at least in part on the received location data and one or more travel parameters. The method further includes receiving, by the one or more computing devices, an input from the user specifying a pick-up location selection based at least in part on the at least one candidate pick-up location. The method further includes providing, by the one or more computing devices, data indicative of the pick-up location selection to a remote computing device.

Other example aspects of the present disclosure are directed to systems, apparatus, tangible, non-transitory computer-readable media, user interfaces, memory devices, and electronic devices for determining pick-up locations.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example mapping interface according to example embodiments of the present disclosure.

FIG. 2 depicts a flow diagram of an example method of providing at least one candidate pick-up location to a user according to example embodiments of the present disclosure.

FIG. 3 depicts a flow diagram of an example method of determining at least one candidate pick-up location according to example embodiments of the present disclosure.

FIG. 4 depicts an example computing system according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to providing one or more candidate pick-up locations to a user. For instance, one or more candidate pick-up locations can be determined proximate a current location of the user. The one or more candidate pick-up locations can be ranked based at least in part on one or more travel parameters, and provided for display to the user in a user interface presented on a display of a display device. The user can select a candidate pick-up location, and the selected pick-up location can be provided to a car service or ride share platform to facilitate a pick-up.

For instance, a user may order a car ride from a car service (e.g. taxi service, limousine service, or other suitable car service) or ride share platform or service via a user device (e.g. smartphone, tablet, laptop, wearable computing device, or any other suitable computing device capable of being carried by a user while in operation). Conventional car service ordering techniques allow a user to provide a starting location and a destination location to the car service. The starting location can be a location corresponding to a current location of a user and can be determined using GPS, IP address, cell triangulation, proximity to Wi-Fi access points, proximity to beacon devices, or other suitable techniques. As indicated above, such starting location can be in the form of raw location data such as latitude, longitude coordinates or other raw location data. Raw location data, such as latitude, longitude coordinates may cause ambiguity as to the exact starting location. For instance, a driver of a car service who receives a starting location in the form of latitude, longitude coordinates may not have enough information to efficiently and quickly locate the user. Such a driver may initially stop at the wrong corner of an intersection. As another example, if a user is located indoors when the user specifies a starting location, the starting location may not be a feasible pick-up location.

In addition, the specified starting location may not be the most efficient location for pick-up. For instance, a slight shift in pick-up location may lead to a shorter and/or cheaper ride. In particular, traffic patterns, street flow patterns (e.g. one way streets, no U-turn, etc.), or other factors may cause varying efficiencies of proximate pick-up locations. In this manner, moving to the opposite side of the road, moving to a proximate intersection, etc. may orient the beginning of a car ride such that the car initially travels in the proper direction.

According to example aspects of the present disclosure, techniques are provided for providing one or more candidate pick-up locations to a user based at least in part on one or more travel parameters. More particularly, a plurality of locations proximate a current location of a user can be analyzed in view of a destination specified by the user and/or in view of one or more travel parameters to determine one or more candidate pick-up locations and to provide the one or more candidate pick-up locations to the user. The one or more travel parameters can include a level of traffic proximate the one or more candidate pick-up locations, an amount of expected time to travel between each candidate pick-up location and the destination, an expected cost to travel between each candidate pick-up location and the specified destination, proximity of the candidate pick-up locations to the current location of the first user, a safety factor associated with the candidate pick-up locations and/or other suitable travel parameters. In example embodiments, the one or more travel parameters can further include one or more user selected preferences.

At least one candidate pick-up location can be provided for display by the user device. Each displayed candidate pick-up location can further include one or more annotations associated with the candidate pick-up location. The annotations may include information relating to one or more aspects or contexts of the location of the candidate pick-up location. For instance, the annotations may include an address of the candidate pick-up location. The annotations may further include a position of the candidate pick-up location relative to a landmark. For instance, the annotations may specify a position relative to a business, building, or other landmark proximate the candidate pick-up location. The annotations may further include information relating to a distance and/or time of travel between the current location of the user and the candidate pick-up location.

The annotations may further include information associated with an expected time and/or cost of travel between the candidate pick-up location and the specified destination. In example embodiments, the annotations may provide a comparison of the expected time and/or cost of travel of two or more candidate pick-up locations. In this manner, the annotations may provide a better description to the user of the actual location of the candidate pick-up location and/or the expected cost of each candidate pick-up location.

The user may select a candidate pick-up location from the list of displayed candidate pick-up locations. Responsive to selecting a pick-up location, the selected pick-up location and/or the specified destination location can be provided to a car service or ride share platform. For instance, the selected pick-up location and the specified destination location can be provided to a user device of one or more employees or drivers associated with the car service or ride share platform, such that one of the one or more employees or drivers may pick the user up in his vehicle. In this regard, the one or more annotations associated with the selected pick-up location can also be provided to the one or more employees or drivers. Such provided annotations can provide to the one or more employees or drivers a better understanding of the location of the user and thereby can reduce the need for additional communication between the user and the one or more employees or drivers to facilitate a pick-up.

In example embodiments, once the pick-up is complete, feedback data associated with the quality of the pick-up location can be obtained. For instance, the feedback data may be direct feedback data obtained directly from a user responsive to a survey (or other questionnaire) presented to the user. As another example, upon obtaining consent from the user, feedback data can be indirect feedback data obtained passively using location data associated with the user for an approximate time period during which the user was in the car. In this manner, the feedback data can be used to assess the quality of the selected pick-up location. For instance, the feedback data can indicate whether the actual pick-up location corresponded to the selected pick-up location, whether the actual cost and/or travel time corresponded to the expected cost and/or travel time, etc.

The feedback data can then be used in determining future candidate pick-up locations proximate the selected and/or actual pick-up location. For instance, the feedback data can be added to the travel parameters associated with the selected and/or actual pick-up location. For instance, the feedback data can be used to determine future candidate pick-up locations responsive to an order from the same user or from one or more other users.

As indicated above, in some embodiments, in order to obtain the benefits of the techniques described herein, a user may be required to allow the collection and analysis of location information associated with a user or device. For example, in some embodiments, users may be provided with an opportunity to control whether programs or features collect such information. If the user does not allow collection and use of such signals, then the user may not receive the benefits of the techniques described herein (e.g. may not be provided information associated with a candidate pick-up location). The user can also be provided with tools to revoke or modify consent. In addition, certain information or data can be treated in one or more ways before it is stored or used, so that personally identifiable information is removed. For example, embodiments of the disclosed technology can be configured to enhance user privacy by removing identifiers for mobile devices or users. In some instances, device and/or user identifiers can be replaced with a lossy device indicator which might conflate a large number of devices or users into a single identifier.

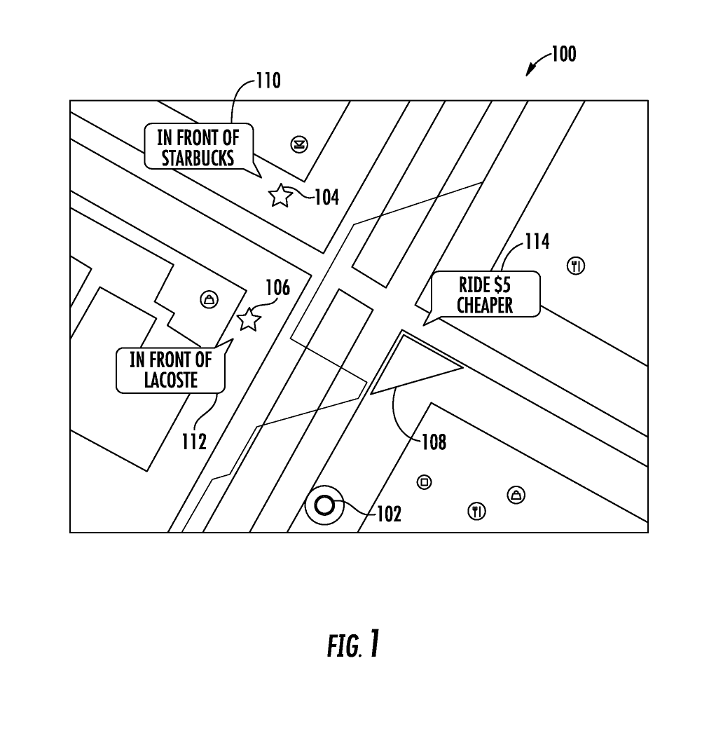

With reference now to the FIGS., example embodiments of the present disclosure will be discussed in further detail. FIG. 1 depicts an example mapping interface 100 suggesting a plurality of candidate pick-up locations according to example embodiments of the present disclosure. In particular, mapping interface 100 depicts a current location 102 associated with a user and candidate pick-up locations 104, 106, and 108 proximate current location 102. Candidate pick-up locations 104-108 can be determined, for instance, responsive to a user input on a user device indicative of a request for a car, taxi, limousine, etc. ride from a car service or ride share platform.

In example embodiments, candidate pick-up locations 104-108 can be determined by ranking a plurality of locations proximate current location 102 based at least in part on one or more travel parameters. For instance, candidate pick-up locations 104-108 can be determined to reduce an amount of time and/or money associated with a car ride from candidate pick-up locations 104-108 to a specified destination relative to an amount of time and/or money associated with a car ride from current location 102 to the specified destination.

Candidate pick-up locations 104-108 can further include one or more annotations 110, 112, 114 displayed in association with candidate pick-up locations 104-108. Annotations 110-114 can provide information relating to a candidate pick-up location, information relating to a car ride from a candidate pick-up location to the specified destination and/or other information. For instance, annotations 110 and 112 include information relating to a position of candidate pick-up locations 104 and 106 respectively relative to a landmark. As depicted, annotation 110 indicates that candidate pick-up location 104 is located “in front of Starbucks.” As another example, annotation 112 indicates that candidate pick-up location 106 is located “in front of Lacoste.” As yet another example, annotation 114 indicates that a car ride from candidate pick-up location 108 to the specified destination has a less expensive (e.g. “$5 cheaper”) expected fare than a car ride from current location 102 to the specified destination. It will be appreciated that further annotations may be displayed including further information. For instance a candidate pick-up location may have an additional annotation providing information relating to a relative cost between the candidate pick-up location and a different candidate pick-up location. As another example, a candidate pick-up location may have an associated annotation providing an indication of the safety of the area proximate the candidate pick-up location.

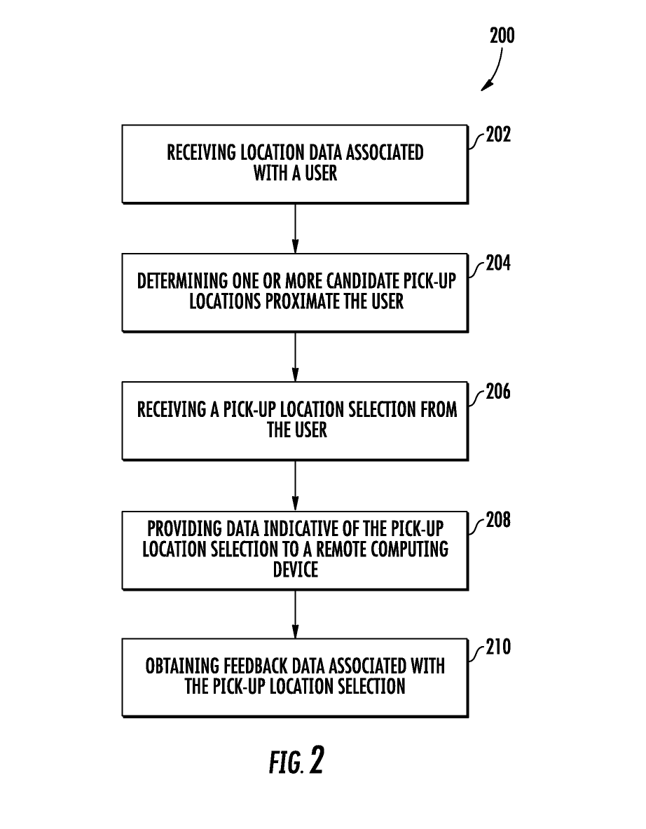

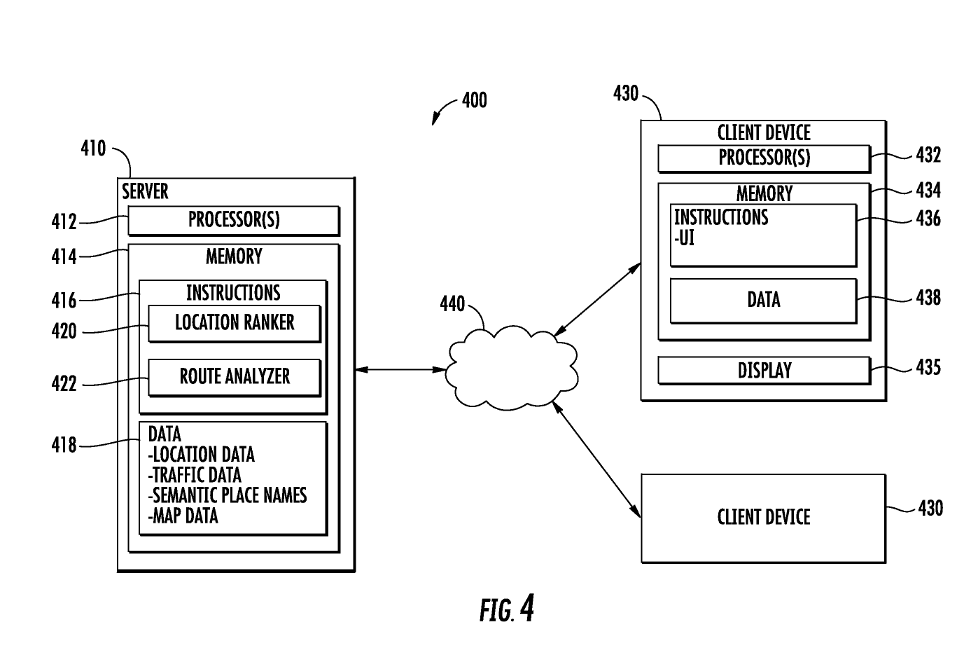

FIG. 2 depicts a flow diagram of an example method (200) of providing one or more candidate pick-up locations to a user according to example embodiments of the present disclosure. Method (200) can be implemented by one or more computing devices, such as one or more of the computing devices depicted in FIG. 4. In addition, FIG. 2 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (202), method (200) can include receiving location data associated with a user. In example embodiments, the location data can be associated with a current location of the user. In example embodiments, the location data may be provided by the user or may be determined using GPS, IP address, cell triangulation, proximity to Wi-Fi access points, proximity to beacon devices, or other suitable location determination techniques. In alternative embodiments, the location data may include data associated with a destination location specified by the user. For instance, a user may input a destination location indicative of an intended destination associated with the user.

At (204), method (200) may include determining one or more candidate pick-up locations proximate the current location of the user. In example embodiments, the candidate pick-up locations can be determined based at least in part on one or more travel parameters associated with the user.

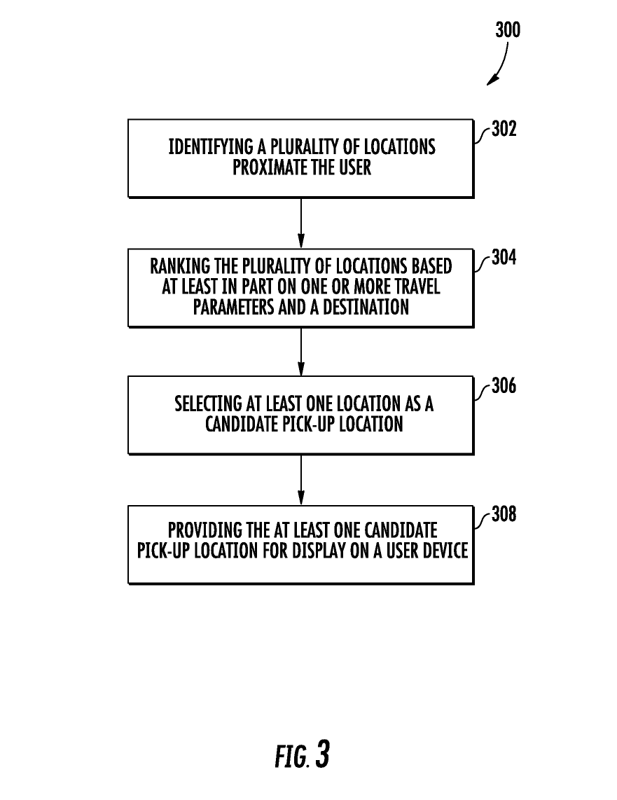

For instance, FIG. 3 depicts a flow diagram of an example method (300) of determining one or more candidate pick-up locations according to example embodiments of the present disclosure. At (302), method (300) can include identifying a plurality of locations proximate the current location of the user. For instance, the plurality of locations can include any location within a threshold distance of the user that can be accessed by a user, such as for instance, a location on a sidewalk, a location in a parking lot, a location on the side of the road, etc. In alternative embodiments, the plurality of locations can include any location within a threshold distance of the user regardless of accessibility to the user.

At (304), method (300) can include ranking the plurality of locations based at least in part on one or more travel parameters. The ranking can be performed by a user device, or by a remote computing device in communication with a user device such as a server device. In example embodiments, the locations can be ranked based at least in part on the one or more travel parameters in view of the destination specified by the user. For instance, the one or more travel parameters may include a level of traffic proximate the one or more candidate pick-up locations, an amount of expected time to travel between each candidate pick-up location and the destination, an expected cost to travel between each candidate pick-up location and the destination, proximity of the candidate pick-up locations to the current location of the first user, a safety factor associated with the candidate pick-up locations and/or other suitable travel parameters. In further embodiments, the one or more travel parameters can further include one or more user selected preferences. In this manner, the plurality of locations can be ranked or otherwise filtered based at least in part on the user selected preferences. For instance, the user selected preferences may provide that safety of the area proximate the pick-up location is to be given additional preference. As another example, the user selected preferences may indicate that the cost of the trip is the most important factor, or that the travel time is the most important factor.

It will be appreciated that the plurality of locations can be ranked or otherwise scored using any suitable ranking technique. For instance, the ranking can be performed using a scoring system specifying a score on a scale of one to one-hundred, or other suitable scale. As another example, the ranking can be performed by ordering the locations by expected travel time to the destination and/or expected cost of travel to the destination.

At (306), method (300) can include selecting at least one location from the ranked plurality of locations as a candidate pick-up location. For instance, selecting the at least one location as a candidate pick-up location may include selecting the top three (or other suitable number) highly ranked locations. As another example selecting the at least one location as a candidate pick-up location may include selecting each location having a ranking or score greater than a threshold. It will be appreciated that other suitable techniques can be used to select candidate pick-up locations without deviating from the scope of the present disclosure.

At (308), method (300) can include providing the at least one candidate pick-up location for display on a user interface presented by a user device. For instance, the at least one candidate pick-up location may be displayed in a mapping application or other geographic information system, such that the annotations overlay a corresponding location represented in the mapping application or geographic information system. As another example, the at least one candidate pick-up location can be displayed in a list format. As indicated above, in example embodiments, one or more annotations may be provided for display in association with the at least one candidate pick-up location.

Referring back to FIG. 2, at (206), method (200) can include receiving a pick-up selection from the user. For instance, the user may provide an input indicative of a selected pick-up location by selecting a candidate pick-up location from the at least one candidate pick-up location. At (208), method (200) can include providing data indicative of the pick-up location selection to a remote computing device. For instance, the data indicative of the pick-up location selection can be provided to a user device of one or more employees or drivers associated with a car service or ride share platform. In this manner, an employee or driver who receives the data indicative of the pick-up location selection can locate the user for pick-up. In example embodiments, the data indicative of the pick-up location selection can include location data corresponding to the pick-up location and/or the one or more annotations associated with the pick-up location. In further embodiments, the driver may further receive data indicative of the specified destination location.

At (208), method (200) may include receiving feedback data associated with the pick-up location selection. For instance, the feedback data may include data provided by the user, or upon obtaining user consent, may include data associated with the user's changing location associated with the ordered car ride. In this manner, the feedback data can be used to assess or otherwise determine the quality of the pick-up location. For instance, the feedback data may be used to compare an actual pick-up location relative to the pick-up location selection. As another example, the feedback data may be used to compare an expected travel cost and/or travel time with an actual travel cost and/or travel time.

In example embodiments, the feedback data may be used in subsequent candidate pick-up location determinations for the user or for a different user. For instance, the feedback data can be used in subsequent rankings of locations proximate a current location of a user to select an at least one candidate pick-up location.

FIG. 4 depicts an example computing system 400 that can be used to implement the methods and systems according to example aspects of the present disclosure. The system 400 can be implemented using a client-server architecture that includes a server 410 that communicates with one or more client devices 430 over a network 440. The system 400 can be implemented using other suitable architectures, such as a single computing device.

The system 400 includes a server 410, such as a web server. The server 410 can host a geographic information system, such as a geographic information system associated with a mapping service, car service and/or ride share platform. The server 410 can be implemented using any suitable computing device(s). The server 410 can have one or more processors 412 and one or more memory devices 414. The server 410 can also include a network interface used to communicate with one or more client devices 430 over the network 440. The network interface can include any suitable components for interfacing with one more networks, including for example, transmitters, receivers, ports, controllers, antennas, or other suitable components.

The one or more processors 412 can include any suitable processing device, such as a microprocessor, microcontroller, integrated circuit, logic device, or other suitable processing device. The one or more memory devices 414 can include one or more computer-readable media, including, but not limited to, non-transitory computer-readable media, RAM, ROM, hard drives, flash drives, or other memory devices. The one or more memory devices 414 can store information accessible by the one or more processors 412, including computer-readable instructions 416 that can be executed by the one or more processors 412. The instructions 416 can be any set of instructions that when executed by the one or more processors 412, cause the one or more processors 412 to perform operations. For instance, the instructions 416 can be executed by the one or more processors 412 to implement a location ranker 420 and/or a route analyzer 422. Location ranker 420 can be configured to identify and rank a plurality of locations based at least in part on one or more travel parameters. Route analyzer 422 can be configured to analyze one or more travel routes between one or more pick-up and destination locations and to determine an expected travel time and/or travel cost associated with the routes.

As shown in FIG. 4, the one or more memory devices 414 can also store data 418 that can be retrieved, manipulated, created, or stored by the one or more processors 412. The data 418 can include, for instance, location data, mapping data, traffic data, semantic place names, and other data. The data 418 can be stored in one or more databases. The one or more databases can be connected to the server 410 by a high bandwidth LAN or WAN, or can also be connected to server 410 through network 440. The one or more databases can be split up so that they are located in multiple locales.

The server 410 can exchange data with one or more client devices 430 over the network 440. For instance, a client device can include a user device associated with a customer of a car or taxi service. As another example, a client device may be a user device or other computing device associated with an employee of a car or taxi service. Although two client devices 430 are illustrated in FIG. 4, any number of client devices 430 can be connected to the server 410 over the network 440. Each of the client devices 430 can be any suitable type of computing device, such as a general purpose computer, special purpose computer, laptop, desktop, mobile device, navigation system, smartphone, tablet, wearable computing device, a display with one or more processors, or other suitable computing device.

Similar to the server 410, a client device 430 can include one or more processor(s) 432 and a memory 434. The one or more processor(s) 432 can include one or more central processing units (CPUs), graphics processing units (GPUs) dedicated to efficiently rendering images or performing other specialized calculations, and/or other processing devices. The memory 434 can include one or more computer-readable media and can store information accessible by the one or more processors 432, including instructions 436 that can be executed by the one or more processors 432 and data 438. For instance, the memory 434 can store instructions 436 for implementing a user interface module for displaying candidate pick-up locations determined according to example aspects of the present disclosure.

The client device 430 of FIG. 4 can include various input/output devices for providing and receiving information from a user, such as a touch screen, touch pad, data entry keys, speakers, and/or a microphone suitable for voice recognition. For instance, the client device 430 can have a display device 435 for presenting a user interface displaying candidate pick-up locations according to example aspects of the present disclosure.

The client device 430 can also include a network interface used to communicate with one or more remote computing devices (e.g. server 410) over the network 440. The network interface can include any suitable components for interfacing with one more networks, including for example, transmitters, receivers, ports, controllers, antennas, or other suitable components.

The network 440 can be any type of communications network, such as a local area network (e.g. intranet), wide area network (e.g. Internet), cellular network, or some combination thereof. The network 440 can also include a direct connection between a client device 430 and the server 410. In general, communication between the server 410 and a client device 430 can be carried via network interface using any type of wired and/or wireless connection, using a variety of communication protocols (e.g. TCP/IP, HTTP), encodings or formats (e.g. HTML, XML, JSON, Protocol Buffers), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of determining pick-up locations, the method comprising:
receiving, by one or more computing devices, location data associated with a user;
determining, by the one or more computing devices, at least one candidate pick-up location proximate the user based at least in part on the received location data and one or more travel parameters;
receiving, by the one or more computing devices, an input from the user specifying a pick-up location selection based at least in part on the at least one candidate pick-up location; and
providing, by the one or more computing devices, data indicative of the pick-up location selection to a remote computing device;
wherein determining the at least one candidate pick-up location comprises:
identifying, by the one or more computing devices, a plurality of locations proximate the first user based at least in part on the received location data associated with the user;
ranking, by the one or more computing devices, the plurality of locations proximate the user based at least in part on the one or more travel parameters and a destination specified by the user, the one or more travel parameters comprising an expected travel time associated with respective routes from the plurality of locations to the specified destination; and
selecting, by the one or more computing devices, at least one of the plurality of locations as a candidate pick-up location based at least in part on the ranking.

2. The computer-implemented method of claim 1, further comprising providing for display, by the one or more computing devices, the at least one candidate pick-up location in a user interface presented on a display device.

3. The computer-implemented method of claim 2, further comprising providing for display, by the one or more computing devices, one or more annotations associated with the at least one candidate pick-up location.

4. The computer-implemented method of claim 3, wherein the one or more annotations overlay a map presented in a mapping application.

5. The computer-implemented method of claim 3, wherein the one or more annotations specify information relating to the at least one candidate pick-up location.

6. The computer-implemented method of claim 5, wherein the information relating to the at least one candidate pick-up location comprises at least one of an address associated with the candidate pick-up location, a position relative to a landmark associated with the candidate pick-up location, or an image associated with the candidate pick-up location.

7. The computer-implemented method of claim 3, wherein the annotations comprise information relating to at least one of an expected cost to travel between at least one candidate-pick-up location and a specified destination, or an expected amount of time required to travel from at least one candidate pick-up location and the specified destination.

8. The computer-implemented method of claim 3, wherein providing, by the one or more computing devices, data indicative of the pick-up location selection to a remote computing device comprises providing the one or more annotations to the remote computing device.

9. (canceled)

10. The computer-implemented method of claim 1, wherein the one or more travel parameters include at least one of a level of traffic proximate the at least one candidate pick-up location, an amount of expected time to travel between each candidate pick-up location and the destination, an expected cost to travel between each candidate pick-up location and the specified destination, or proximity to the current location of the first user.

11. The computer-implemented method of claim 1, wherein the one or more travel parameters comprise one or more user selected preferences.

12. The computer-implemented method of claim 1, further comprising receiving, by the one or more computing devices, feedback information associated with the user, the feedback information assessing a quality of the pick-up location selection.

13. The computer-implemented method of claim 12, further comprising adding the received feedback information to the one or more travel parameters associated with the pick-up location selection.

14. The computer-implemented method of claim 12, wherein the feedback information comprises at least one of direct feedback information received directly from the user, or indirect feedback information obtained passively using location data associated with the user for an approximate time period associated with the pick-up.

15. A computing system, comprising:
one or more processors; and
one or more computer-readable media, the one or more computer-readable media storing computer-readable instructions that when executed by the one or more processors cause the one or more processors to perform operations, the operations comprising:
receiving location data associated with a user;
determining one or more candidate pick-up locations proximate the user based at least in part on the received location data and one or more travel parameters;
receiving an input from the user specifying a pick-up location selection based at least in part on the one or more candidate pick-up locations; and
providing data indicative of the pick-up location selection to a remote computing device;
wherein determining the one or more candidate pick-up locations comprises:
identifying a plurality of locations proximate the first user based at least in part on the received location data associated with the user;
ranking the plurality of locations proximate the user based at least in part on the one or more travel parameters and a destination specified by the user, the one or more travel parameters comprising an expected travel time associated with respective routes from the plurality of locations to the specified destination; and
selecting at least one of the plurality of locations as a candidate pick-up location based at least in part on the ranking.

16. One or more tangible, non-transitory computer-readable media storing computer-readable instructions that when executed by one or more processors cause the one or more processors to perform operations, the operations comprising:
receiving location data associated with a user;
determining one or more candidate pick-up locations proximate the user based at least in part on the received location data and one or more travel parameters;
receiving an input from the user specifying a pick-up location selection based at least in part on the one or more candidate pick-up locations; and
providing data indicative of the pick-up location selection to a remote computing device;
wherein determining the one or more candidate pick-up locations comprises:
identifying a plurality of locations proximate the first user based at least in part on the received location data associated with the user;
ranking the plurality of locations proximate the user based at least in part on the one or more travel parameters and a destination specified by the user, the one or more travel parameters comprising an expected travel time associated with respective routes from the plurality of locations to the specified destination; and
selecting at least one of the plurality of locations as a candidate pick-up location based at least in part on the ranking.
